(19) United States
(12) Patent Application Publication
(10) Pub. No.: US 2004/0217877 A1
(43) Pub. Date: Nov. 4, 2004

(54) Flexible electronic display and wireless communication system

(76) Inventors: William Kokonaski, Gig Harbor, WA (US); Ronald D. Blum, Roanoke, VA (US); Dwight P. Duston, Laguna Niguel, CA (US)

Correspondence Address: KENYON & KENYON, 1500 K STREET, N.W., SUITE 700, WASHINGTON, DC, 20005, US

(21) Appl. No.: 10/804,090

(22) Filed: Mar. 19, 2004

Related U.S. Application Data
(63) Continuation-in-part of application No. 10/682,435, filed on Oct. 10, 2003.
Application No. 10/682,435 is a continuation-in-part of application No. 10/438,923, filed on May 16, 2003.
Application No. 10/438,923 is a continuation-in-part of application No. 10/285,639, filed on Nov. 1, 2002.
Application No. 10/285,639 is a continuation of application No. 10/137,357, filed on May 3, 2002, now Pat. No. 6,507,285.
Application No. 10/137,357 is a continuation of application No. 09/767,846, filed on Jan. 24, 2001, now Pat. No. 6,417,778.
Application No. 09/767,846 is a continuation of application No. 09/418,752, filed on Oct. 15, 1999, now abandoned.
Application No. 09/418,752 is a continuation-in-part of application No. 09/304,051, filed on May 4, 1999, now Pat. No. 6,219,876.
(60) Provisional application No. 60/457,115, filed on Mar. 21, 2003.
(60) Provisional application No. 60/460,353, filed on Apr. 3, 2003.
(60) Provisional application No. 60/418,626, filed on Oct. 12, 2002.
(60) Provisional application No. 60/428,387, filed on Nov. 21, 2002.
(60) Provisional application No. 60/429,044, filed on Nov. 23, 2002.

(51) Int. Cl. G08B 5/00

(52) U.S. Cl. 340/815.4

(57) ABSTRACT

Various inventive embodiments provided herein are provided that comprise a flexible, low cost electronic display system, having wireless communication capabilities, providing dynamic or still images and being designed and utilized in various novel ways.

This application claims the benefit under 35 USC §119(e) of provisional application 60/457,115, filed Mar. 21, 2003 and of provisional application 60/460,353 filed Apr. 3, 2003. Moreover, this application is a continuation-in-part of application Ser. No. 10/682,435, filed Oct. 10, 2003. Application Ser. No. 10/682,435 is a continuation-in-part of application Ser. No. 10/438,923, filed May 16, 2003, and claims the benefit of under 35 U.S.C. § 119(e) of U.S. provisional applications identified as follows: application Ser. No. 60/418,626, filed Oct. 12, 2002; application Ser. No. 60/428,387, filed Nov. 21, 2002; and application Ser. No. 60/429,044, filed Nov. 22, 2003. Application Ser. No. 10/438,923 is a continuation-in-part of co-pending application Ser. No. 10/285,639, filed Nov. 1, 2002, which is a continuation of application Ser. No. 10/137,357, filed May 3, 2002, and issued as U.S. Pat. No. 6,507,285 on Jan. 14, 2003. Application Ser. No. 10/137,357 is a continuation of application Ser. No. 09/767,846, filed Jan. 24, 2001, and issued as U.S. Pat. No. 6,417,778 on Jul. 9, 2002. Application Ser. No. 09/767,846 is a continuation of application Ser. No. 09/418,752, filed Oct. 15, 1999, and now abandoned. Application Ser. No. 09/418,752 is a continuation-in-part of application Ser. No. 09/304,051, filed May 4, 1999, and issued as U.S. Pat. No. 6,219,876 on Apr. 24, 2001. Each of the above-identified applications is fully incorporated herein by reference.

### BACKGROUND

Various applications for electronic display technology are known for conveying information such as advertising messages. However, there exist many potential applications for electronic display technology that are as yet unexploited. Whereas known applications typically place electronic displays in “vertical space” in that the displays are oriented more or less vertically, there is much promise in less traditional applications. For example, “horizontal space” is largely untapped in terms of use for electronically conveying information.

One obstacle to exploiting horizontal space and other non-traditional applications is that electronic display technology can be expensive. This may discourage the use of electronic display technology in non-traditional ways. Accordingly, there is a need for a low-cost electronic display technology that can be easily adapted for use in non-traditional applications.

### BRIEF DESCRIPTION OF THE DRAWINGS

FIGS. 1A and 1B show an example of an electronic display system comprising a flexible carrier material and associated electronic display device according to embodiments of the present invention;

FIG. 2 shows a block diagram of an electronic display system according to embodiments of the present invention;

FIGS. 3, 3A, 3B and 3C show details of an active matrix display device according to embodiments of the present invention;

FIGS. 4 and 4A show a top view and a cross-sectional view, respectively, illustrating details of an electro-chromic cell according to embodiments of the present invention;

FIGS. 5 and 5A show a top view and a cross-sectional view, respectively, illustrating details of an electro-chemical transistor according to embodiments of the present invention;

FIG. 6 shows details of implementation of an organic light-emitting diode according to embodiments of the present invention;

FIGS. 7, 7A, 7B, 8-12, 12A and 13 show examples of applications of embodiments of the present invention; and

FIG. 14 shows a flexible electronic display system according to alternative embodiments of the present invention.

### DETAILED DESCRIPTION

Embodiments of the present invention relate to a low-cost and adaptable electronic display system comprising a flexible carrier material associated with an electronic display. The electronic display system may further comprise a power source, a controller, a memory and at least one communication port. To provide for low cost and adaptability, the flexible carrier material may be constructed of a low-cost material and the electronic display may be formed using a low-cost fabrication technique. Because of its low cost, the electronic display system could be used in various applications wherein it is treated as being essentially disposable. For example, the system could be used and then be disposed of after a few months, weeks, or days, depending on the application. Moreover, because of its flexibility, the carrier material and associated display device may conform to many different surfaces, including horizontal and curved surfaces, thus allowing the system to be used to inexpensively convey information in horizontal space and other non-traditional ways.

Embodiments of the present invention further relate to methods for forming an information medium and distributing the information medium publicly, where the information medium comprises a flexible carrier material, an electronic display device associated with the flexible carrier material, a controller coupled to the electronic display device and programmable to cause the electronic display device to display arbitrary content, a memory coupled to the controller to store the content, and at least one communication port coupled to the controller. The information medium may be used for any of a number of non-traditional applications for conveying information electronically, such as in restaurant menus, on place mats, in periodicals such as magazines, in maps, on floor mats, on posters, and the like.

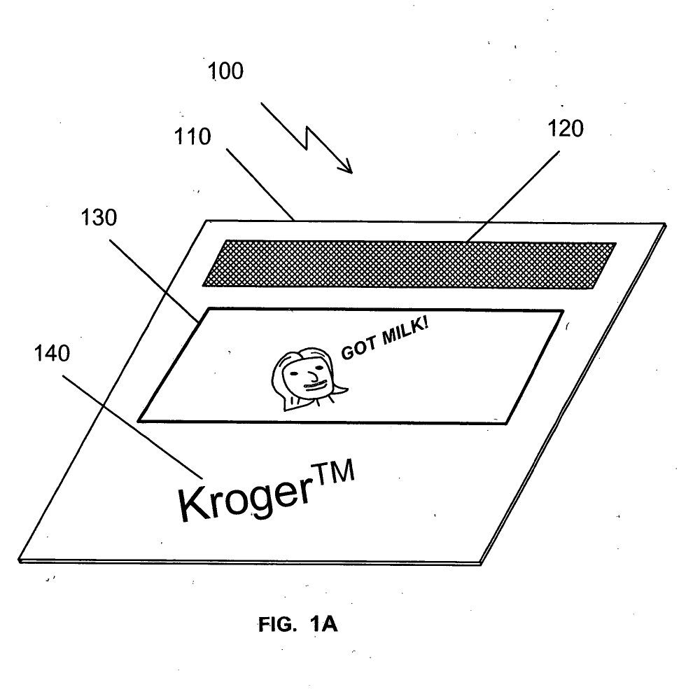

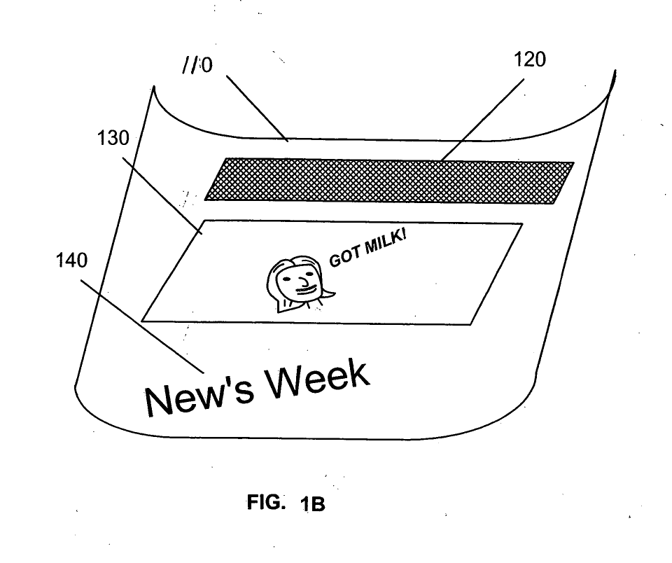

An example of a low-cost adaptable electronic display system 100 according to embodiments of the present invention is illustrated in FIG. 1A. The system 100 includes a flexible carrier material 110. The carrier material 110 could be at least partly formed from an inexpensive, flexible material such as paper or plastic film. The flexible nature of the carrier material 110 is illustrated in FIG. 1B. An electronic display device 130 may associated with the carrier material 110. For example, the electronic display device 130 may be formed in or on the carrier material 110.

Low-cost processes to form the electronic display device 130 include printing by means of, for example, ink jet, laser, or silkscreen. Such printing techniques can be used to apply image-forming elements such as pixels and associated driving electronics directly onto the carrier material 110. The image-forming elements and driving electronics may comprise semi-conductive polymeric inks, and/or conductive polymers applied by means of the printing process. The carrier material 110 may also include a static image or advertisement 140.

A power source 120 of the system could be provided on the flexible carrier material 110. The power source 120 could comprise, for example, a photovoltaic cell array printed onto the carrier material 110. The cell array could be produced using conductive polymers, such as polythiophene or other suitable conjugated polymer. The power source 120 could be in an area of the carrier material 110 that is separate from the display 130 as shown in FIG. 1A, or could be integrated with the display 130. In embodiments, the power source 120 may alternatively be, for example, one or more of a conventional battery, a thin-film battery, photoelectric cells, fuel cells, or conventional wall-plug electricity.

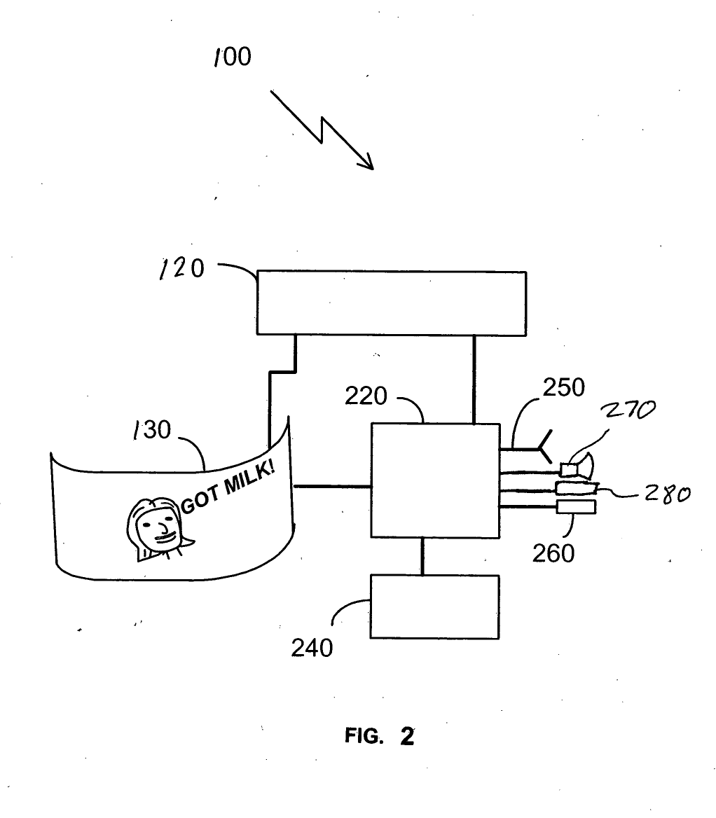

FIG. 2 illustrates elements of the electronic display system 100 in diagram form. The power source 120 may be coupled to the electronic display device 130 and to a controller 220 to provide electrical power thereto. The controller 220 may further be coupled to the display device 130 and control content of a display on the display device 130. The controller 220 may comprise programmable logic circuitry such as a processor and/or ASIC (application-specific integrated circuit). The electronics of the display device 130 may comprise, by way of example only, OLEDs (organic light emitting diodes of either the small or large molecule variety), LEP (light emitting polymer, electrophoretic display technology, electro-chromic devices, or nematic or cholesteric liquid crystal devices that may be printed on the carrier material 110, for example, as described above. An image displayed on the display device 130 may be monochromatic or in color.

Arbitrary display content may be stored in a memory device 240 coupled to the controller 220. The display content may include any or all of letters, words, numbers and pictures, either still or dynamic (moving). The memory device could be on a surface of or integrated into the carrier material 110 (see FIGS. 1A, 1B). The memory device 240 may include flash or other solid-state electronic storage devices designed to function as non-volatile memory. The memory device 240 may be constructed, for example, from thin-film circuitry using polycrystalline silicon, amorphous silicon, or organic semiconductors, or inorganic semiconductors.

Control software and other data may be loaded into the memory 240 under control of the controller 220 using at least one communication port coupled to the controller 220. Communication ports coupled to the controller 220 may include a wireless port 250 and/or an I/O port 260 to make a physical connection. By means of either the wireless port 250 or the I/O port 260, the system 100 may be coupled to a computer to receive data and/or control signals from the computer. Since the carrier material 110 may be flexible, the physical connection may be facilitated, for example, with a flex or ribbon connector. The wireless port 250 may comprise an antenna buried into or printed onto the carrier material 110 and connected to a transceiver circuit built into the controller 220. The electronic display system 100 could also be coupled via communication port 250 and/or 260 to a network such as the Internet or World Wide Web and programmed remotely via the network by, for example, downloading control software and display content into the memory 240. Additionally or alternatively, the electronic display system 100 could be programmed and reprogrammed by simply replacing the memory 240. To facilitate this, the memory 240 could be embodied on a replaceable chip such as a flash card.

An audio device 270 such as a speaker may further be associated with the electronic display system 100 and output audio content under the control of the controller 220. A sensing device 280 may further be associated with the electronic display system 100 and detect events occurring in the proximity of the electronic display system 100. Based on detecting an event such as the approach of a person, the sensing device may send a signal to the controller 220 to cause it to generate a corresponding display and/or sound via the display device 130 and/or audio device 270, respectively. The sensing device 280 could comprise, for example, a motion sensor and/or a pressure sensor. The motion sensor could comprise, for example, a light-sensitive device such as a photodiode.

The controller 220 may provide addressing and data logic for driving displays on the display device 130. The displays could be at varying levels of resolution, with corresponding technologies in the controller 220. For example, to perform high-resolution graphics rendering, the controller 220 may be constructed from semiconductor materials such as single crystalline silicon processed on silicon wafers to provide the necessary processing speed. Alternatively, in applications where the resolution is lower and data rates are less critical, it may be possible to use thin-film transistors produced on plastic films or paper using polycrystalline silicon, amorphous silicon, or organic semiconductors.

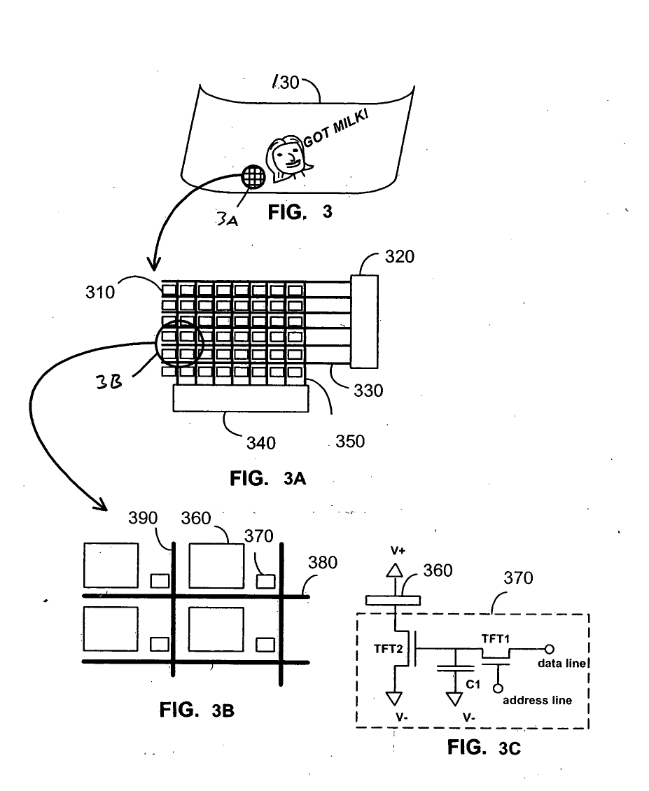

One kind of display technology that may be used in the display device 130 is “active matrix” (AM) technology. FIG. 3 illustrates details that may be involved in producing an active matrix display for use in the display device 130 according to embodiments of the present invention. To produce an active matrix display, the display device 130 may comprise thousands or perhaps hundreds of thousands of sub picture elements known as pixels. FIG. 3A is a magnified view of a small area 310 of the display device 130. Individual pixels make up the images that are displayed on display device 130. The pixels are controlled by address driver electronics 340 that provide power to address buses 350 and data driver circuits 320 that provide data to data buses 330. The address buses 350 determine which column receives data supplied to the data buses 330. In cases where the display device 130 is light-emitting and where a colored image is desired, each pixel may comprise a green, red, and blue sub-pixel. In FIG. 3B sub-pixel elements 360 are shown with associated transistor driving elements 370 that are nested between rows of data buses 330 and column address buses 350. The transistor driving element 370 may be a Field Effect Transistor of either the PMOS or NMOS variety and may be constructed from organic semiconductors, amorphous silicon or polycrystalline silicon, depending upon the service temperature of a substrate in or on which they are in use. FIG. 3C illustrates an example drive circuit 370 comprising two transistors and one capacitor used to select and drive a sub-pixel element in the display. Other circuits are also possible, such as TFT (thin film transistor) circuits.

Notwithstanding the foregoing specific examples discussed, in embodiments of the present invention, the sub-pixel and/or pixel element need not be of any particular type, and may include, by way of example only, OLEDs, electro-chromic devices, electronic ink, or any device that changes its optical properties or appearance when electricity is applied to the device. It is further observed an active matrix arrangement as described above could be used as an imaging system where the sub-elements are photosensitive and the data lines are read by the controller 220 as opposed to driven by the controller 220. In such a manner, embodiments of the present invention may also be used as an imaging system to, for example, record the faces of observers looking at the display.

In embodiments where paper is used in the carrier material 110, electro-chromic devices may be used to create a reflective display device 130. Such embodiments may comprise a pixel arrangement akin to the four-color process for printing. The four basic colors used to create the exact color specified by a graphics application program are generally referenced as CMYK. “C” represents Cyan or blue, “M” represents magenta or red, “Y” represents yellow, and “K” represents black. To support the generating of these colors, four sub-pixels may be used unless the color purity of the Cyan, Magenta and Yellow devices is adequate to produce black when combined in equal or nearly equal proportions. While the display device 130 may use addressing in a similar manner to that described above in connection with an active matrix, the image generated may need to be translated from RGB (Red Green Blue as used in emissive displays) format to CMY or CMYK format. This translation is well known in the computer application software art. In any regard, the basic electro-chromic device may comprise a two-electrode device, where each electrode comprises a blend of conductive polymers with electro-chromic properties appropriate for producing color variations at different applied electrical potentials. The active matrix transistor circuits can be printed on the carrier material 110 with inks formulated from organic semiconductors and/or conductive polymers.

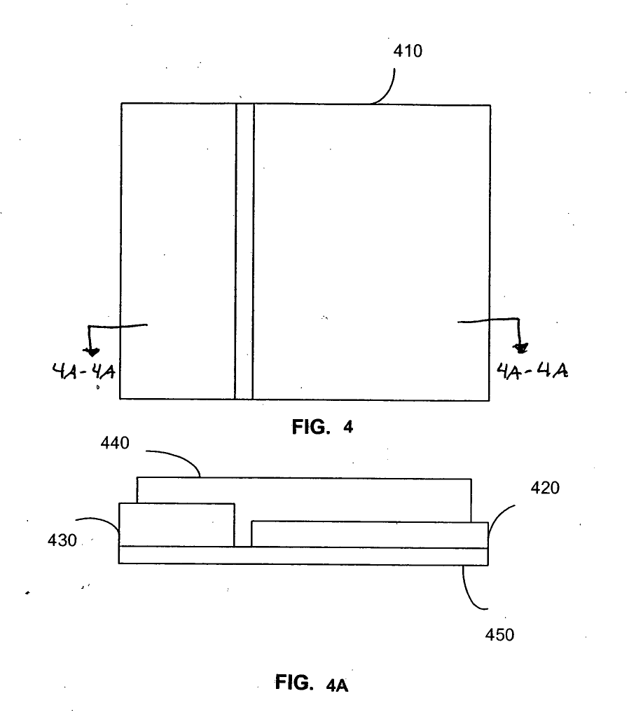

FIG. 4 illustrates an example of an electro-chromic cell 410. A cross-sectional view of the cell 410 is shown FIG. 4A. An electrode 420 is deposited onto a substrate 450 along with a counter electrode 430 that is smaller in area but thicker than the electrode 420. A solid or semi-solid electrolyte 440 is place over the two electrodes. Possible solid electrolytes include but are not limited to polyacrylamide, polyethyleneoxide, and polystyrenesulphonate, and Nafion. Nafion belongs to the wide class of solid super-acids catalysts, in that it exhibits acid strength greater than that of 100% H₂SO₄. It has hydrophobic (—CF₂—CF₂—) and hydrophilic (—SO₃H) regions in its polymeric structure, and its super-acidity is attributed to the electron-withdrawing effect of the perfluoro-carbon chain acting on the sulfonic acid group. By applying a potential across the electrodes the reflectance of the electrode 420 will vary with the magnitude of the applied potential. Electrode materials include, by way of example only, conjugated polymers films such as 3,4-ethlyenedioxythiophene:poly(styrene sulfonate) (PEDOT:PSS), polyaniline, polypyrrole, and other conductive polymers which possess electro-chromic properties.

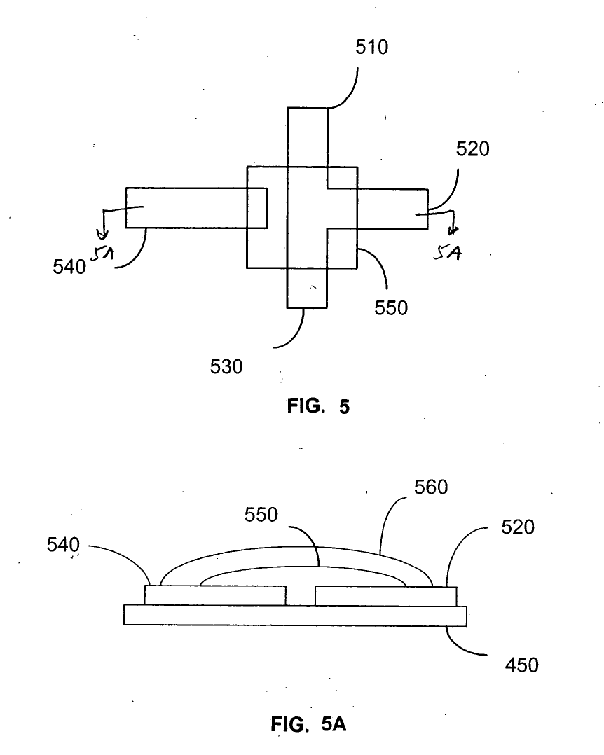

FIG. 5 and FIG. 5A show a top view and a cross sectional view, respectively, of an example of an electrochemical transistor 500 that may be used to produce a transistor circuit for active matrix addressing in an active matrix display that may utilize electro-chemical cells such as the electro-chromic cell 410 described above. The transistor 500 is formed by printing a “T” shape area of conductive polymer to form the drain 550, source 510, and one of two gates 520 for the transistor. A second area of conductive polymer in the shape of a rectangle is printed to form the second gate 540 contact. Conductive polymers used to make the electrodes for the electro-chromic cells can also be used to product the transistors and include, by way of example only, conjugated polymers films such as 3, 4-ethlyenedioxythiophene:poly(styrene sulfonate) (PEDOT:PSS), polyaniline, polypyrrole, and other conductive polymers which possess variable electrical properties depending upon the doping state of the polymer which can be controlled by applying varying potentials across the two gate contacts. A layer of solid electrolyte 550 is placed over the polymer electrodes to provide a source of ions, which move in and out of the polymer film to change the film's electrical properties. Possible solid electrolytes include but are not limited to polyacrylamide, polyethyleneoxide, polystyrenesulphonate, and Nafion. The solid electrolyte is then covered with an encapsulation layer 560.

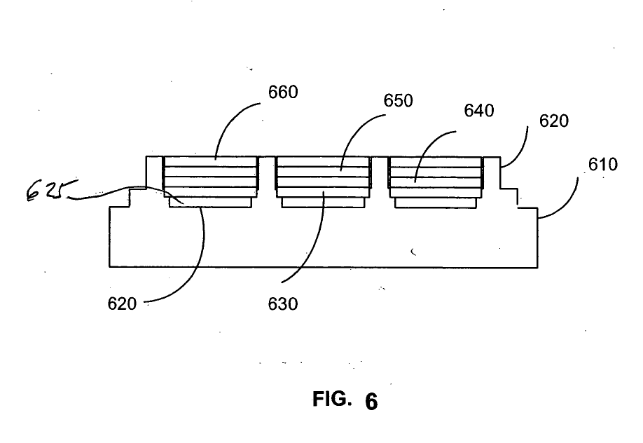

As noted earlier, embodiments of the electronic display device 130 may comprise an OLED (organic light emitting diode) structure. FIG. 6 shows a side view of a portion of material 610 that could be used in a carrier material 110 according to embodiments. The material 610 may have formed therein pre-patterned wells 620 containing bank structures. The material 610 could include, for example, substances such as polyimide, polyetherimide, polyester, and polyethylenenapthalate. Amorphous silicon, polysilicon, or organic semiconductor TFT circuits 625 are formed at the bottom of the wells. The wells are then coated with a thin transparent conductor 630 such as ITO. One or more organic thin films or first polymer layer 640 in a thickness between 50 to 150-nm thick are deposited from solution using a printing technique. This first polymer layer 640 may be a non-emissive conducting polymer, poly-ethylenedioxythiophene (PEDOT) or polyaniline doped with poly-styrenesulphonic acid (PSS), which serves as a hole-injecting layer. A second polymer layer 650 may be deposited and may be an emissive polymer used to create either red, green or blue light. Examples of emissive polymers include Poly(p-phenylenes) PPP, Poly(phenylenes vinylenes) PPV, Dimethoxy-PPV, methoxy-ethyllhexyloxy-PPV, polyflourenes, dimethyl-polyflourene. Finally, a metallic cathode 660 may be deposited on top of the emissive layer 650.

As noted earlier, the electronic display system according to embodiments of the present may be made with inexpensive materials, such that it would be in effect disposable. Accordingly, elements of the system could be specifically designed for a comparatively brief period of use. For example, the memory capacity of the system could be designed to hold only a small amount of data that is useful only for a short period of time.

On the other hand, embodiments of the invention could be designed to be reusable. For example, the system could be designed to be reprogrammed over and over again with new information. In the latter case, embodiments of the invention may be constructed of more durable materials than in the embodiments where disposability is desired. To make the system more durable, for example, the carrier material 110 may be laminated with plastics such as, by way of example only, polyethylene, polyester, polypropylene or other water-resistant plastics. In embodiments, the carrier material 110 may even have a protective outer layer formed from a durable transparent material such as hardened glass to prolong its useful life.

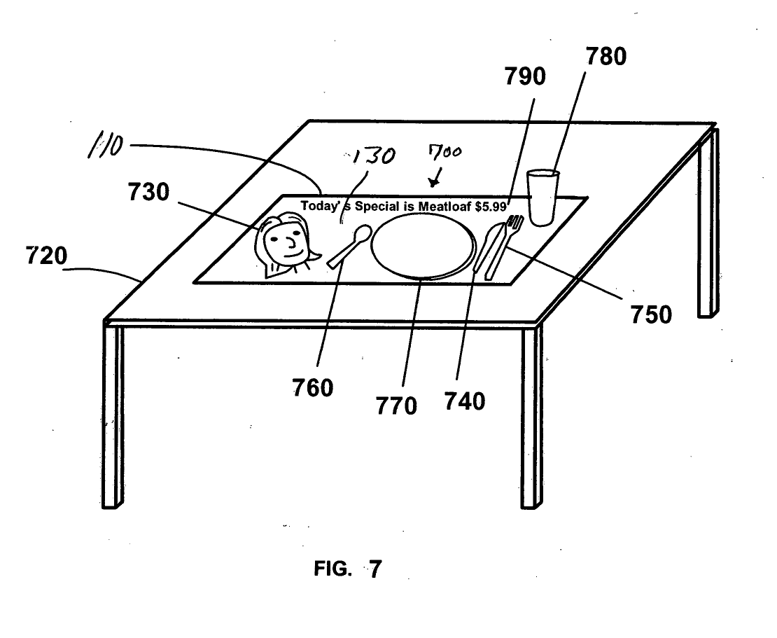

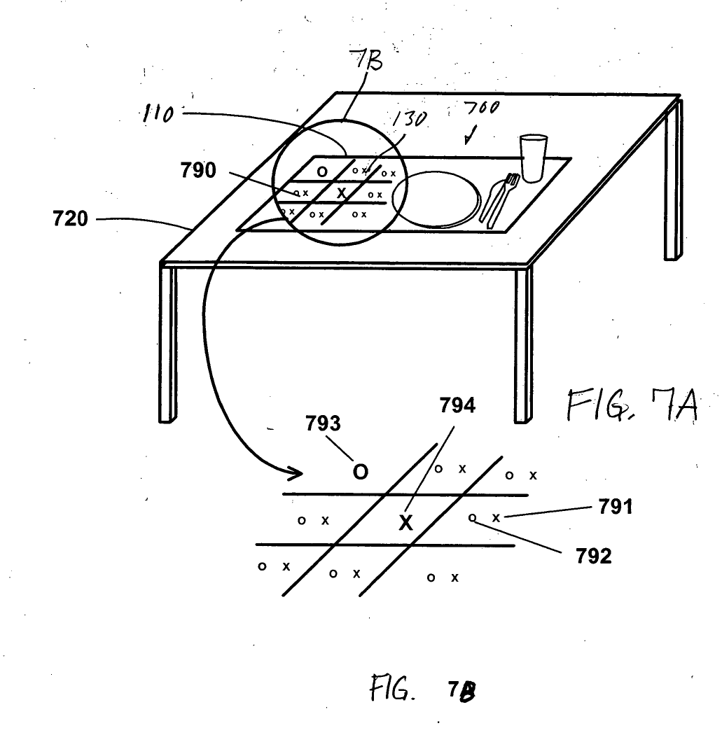

FIG. 7 illustrates one possible inventive embodiment of the present invention. In FIG. 7, a carrier material 110 and associated electronic display device 130 form at least part of a place mat 700 placed on a table 720, for example in a restaurant. Others of the elements of system 100 as shown in FIG. 2 may be incorporated into the place mat, but are not illustrated. The electronic display device 130 may display a still or moving image including any or all of letters, words, numbers and pictures. The image content may be stored in a memory 240 (see FIG. 2) and the display device 130 may display the content under the control of a controller 220 (see FIG. 2). In the example of FIG. 7, a picture 730 and a text message 790 are displayed electronically on the covering, and could relate, for example, to advertising. The place mat could additionally include a fixed printed image. The place mat is shown with a typical table setting of knife 740, fork 750, and spoon 760, along with a plate 770 and a glass 780.

FIG. 7A illustrates an embodiment wherein an interactive, electronic game 790 is incorporated into a place mat 700 resting on a table 720. FIG. 7B shows an enlarged view of the game 790. In this case the game is “tic tac toe”. In each square of the game a small “o” 792 and a small “x” 791 is displayed. By using a touch screen display, which are well known in the display art, a square can be chosen as containing an large “X” 794 or a large “O” 793, when the players press on the display on either the smaller “x” 791 or the smaller “o” within a given square. Since the display is dynamic and the program in the display device that is contained within the place mat can be reprogrammed, any number of games can be selected for display and play on the place mat, and the present invention is therefore not limited to the game of “tic tac toe”.

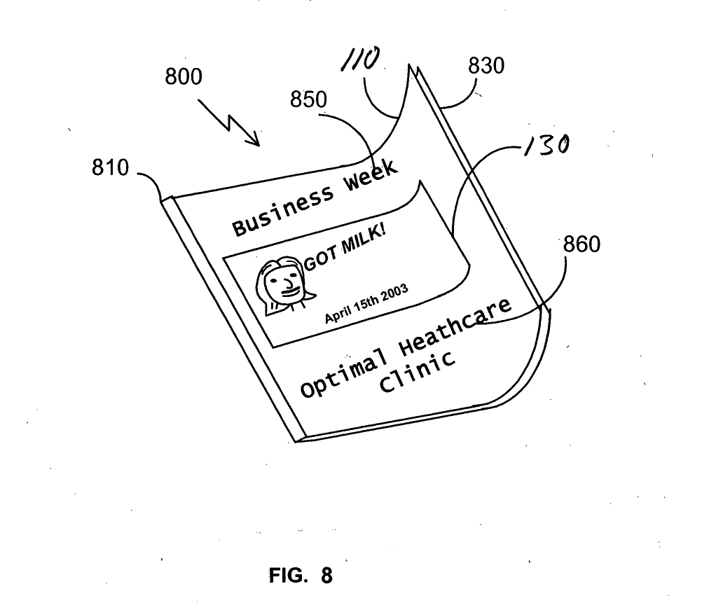

FIG. 8 illustrates another possible inventive embodiment of the present invention. In FIG. 8, a carrier material 110 and associated electronic display device 130 form at least part of a cover of a periodical cover or other publication cover such as a magazine cover 800. Others of the elements of system 100 as shown in FIG. 2 may be incorporated into the cover, but are not illustrated. The electronic display device 130 may display a still or moving image including any or all of letters, words, numbers and pictures. The image content may be stored in a memory 240 (see FIG. 2) and the display device 130 may display the content under the control of a controller 220 (see FIG. 2). The inventive magazine cover has a spine or magazine binder 810 made from any number of materials including by way of example only, plastic, metal, or cardboard. The carrier material 110 may include a non-electronic message 850 such as the name of the magazine. The cover may also contain the name of the practice or business 860 where the magazine may reside, such as by way of example only at a book store, magazine store, doctor's office, beauty salon, law office, or professional office. A back sheet 830 may also be attached to the spine to provide additional protection for the magazine, and may or may not include an electronic display. The inventive display cover will therefore allow for the ability to wirelessly change the message or advertisement displayed on the cover. This can be particularly advantageous to either the magazine publisher, or the owner of the office or store where the inventive display cover will reside.

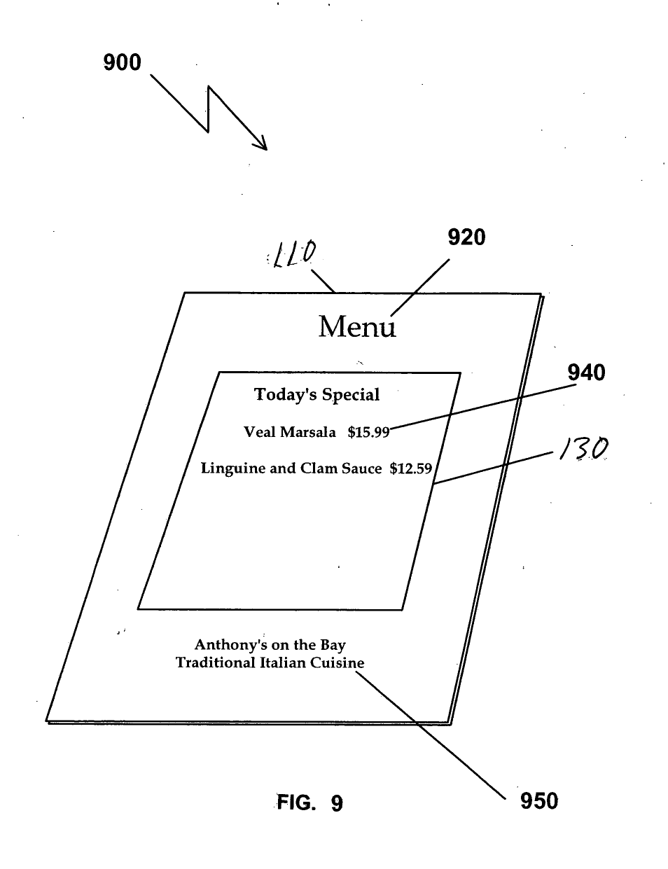

FIG. 9 illustrates a still further possible application for embodiments of the present invention. In FIG. 9, a carrier material 110 and associated electronic display device 130 form at least part of a menu 900. Others of the elements of system 100 as shown in FIG. 2 may be incorporated into the menu, but are not illustrated. The electronic display device 130 may display a still or moving image including any or all of letters, words, numbers and pictures, where the image content may be stored in a memory 240 (see FIG. 2) and displayed under the control of a controller 220 (see FIG. 2). The carrier material 110 may include a combination of fixed-print information 920 and 950 that might be used to provide the name of the establishment or other information that need not be updated frequently. The electronic display 130 may include information that is changed frequently such as daily specials 940. The electronic display device 130 may also be used to advertise other businesses near the establishment, such as nightclubs, golf courses, or auto dealers.

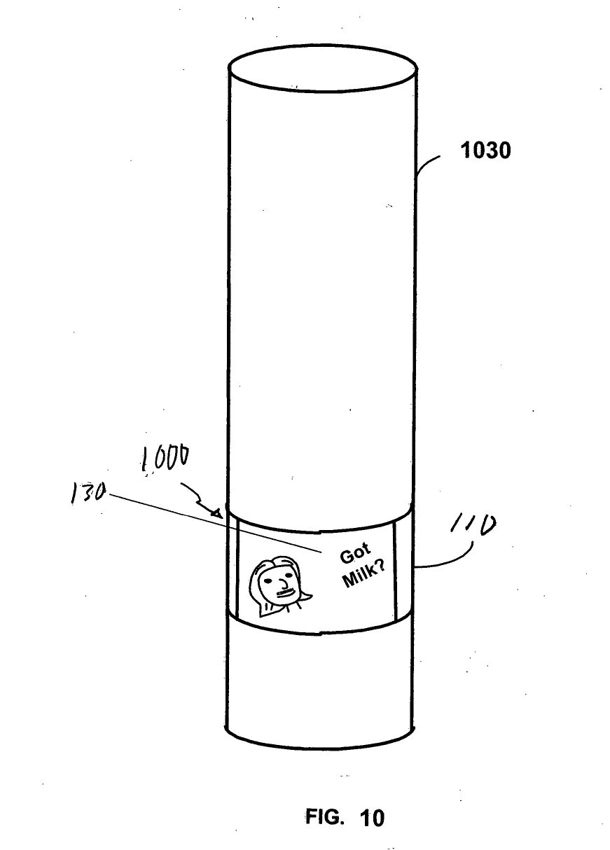

FIG. 10 illustrates yet another possible application for embodiments of the present invention. In FIG. 10, a carrier material 110 and associated electronic display device 130 form at least part of a poster 1000. Others of the elements of system 100 as shown in FIG. 2 may be incorporated into the poster, but are not illustrated. The poster 1000 is wrapped around a utility pole 1030 and conforms to the curved shape of the utility pole. The electronic display device 130 may display a still or moving image including any or all of letters, words, numbers and pictures, where the image content may be stored in a memory 240 (see FIG. 2) and displayed under the control of a controller 220 (see FIG. 2). FIG. 10 is an illustration of how the flexibility of the electronic display system 100 according to embodiments of the present invention provides for non-traditional applications. That is, FIG. 10 shows how the electronic display device 130 can be used to advertise on a curved surface that normally would not be used for electronic, dynamic (moving image) advertising. In outdoor applications such as this, the solar cells as described above could be used, for example, to provide power.

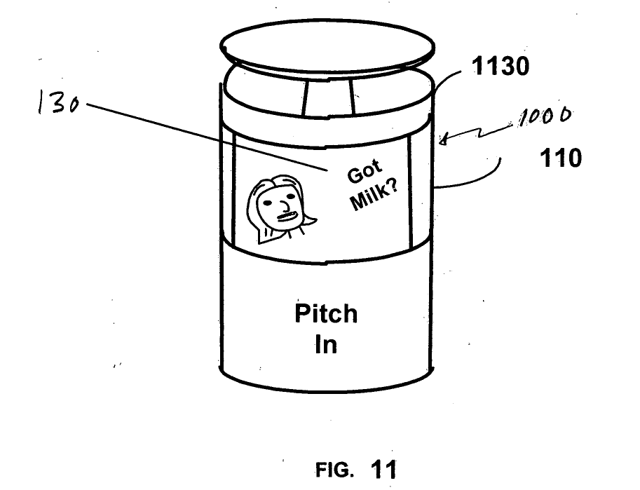

FIG. 11 illustrates another non-traditional application for electronic, moving-image advertisement. In FIG. 11, the carrier material 110 and associated electronic display device form at least part of a poster 1000 that is fastened to a garbage can 1030 and conforms to the curved shape of the garbage can. The electronic display device 130 may again be used to display advertising content. In outdoor applications such as this, the solar cells as described above could be used to provide power to the device.

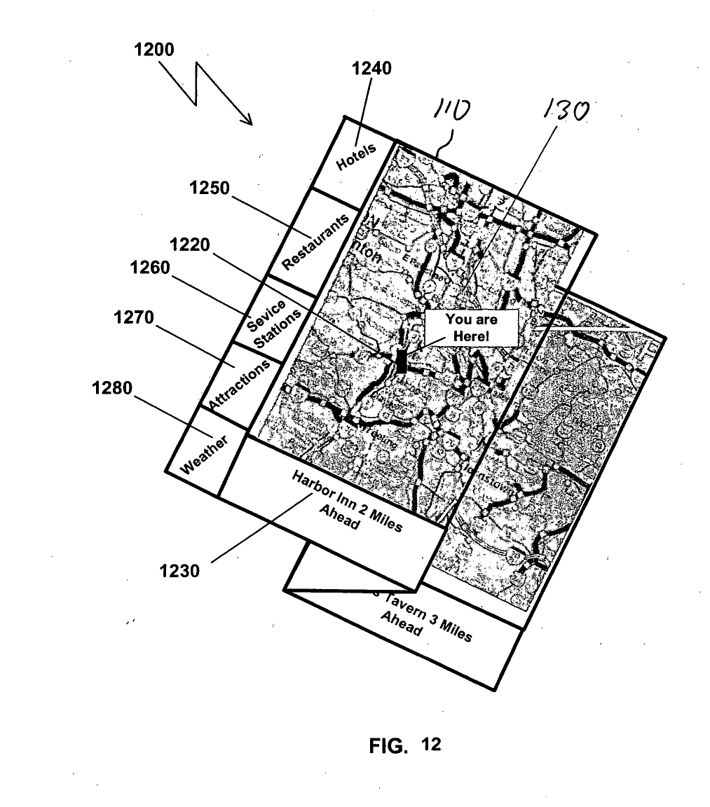

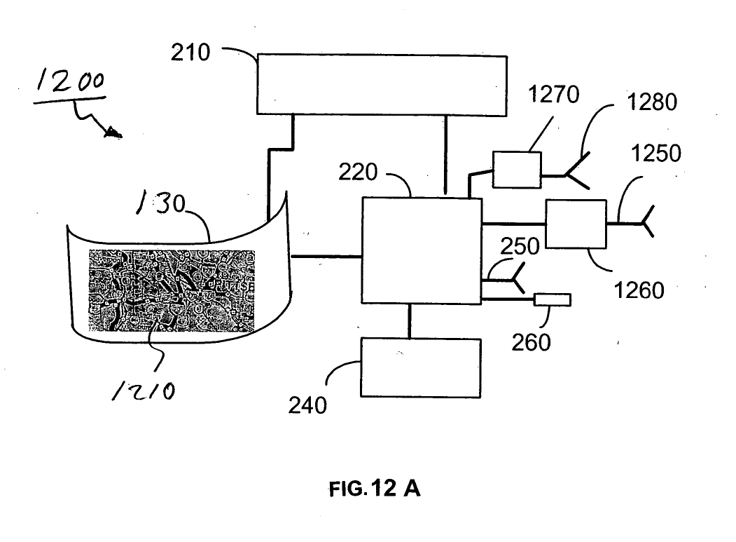

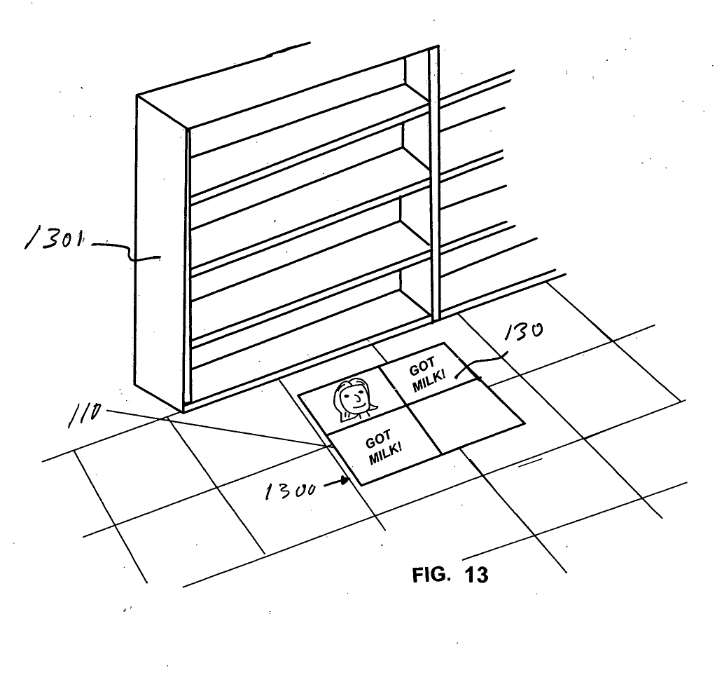

FIG. 12 illustrates yet another inventive embodiment of the present invention. In FIG. 12, a carrier material 110 and associated electronic display device 130 form at least part of a foldable or rollable map 1200. The map 1200 may provide real-time location information to a user as he or she travels by means of wireless communication with a data network such as the Internet or World Wide Web, and/or with a global positioning satellite (GPS) system, as discussed further below with reference to FIG. 12A. The location information may enable a display of an area in the vicinity of the map 1200 and the map's location 1220 (and thus the location of a map user) therein. Other parts of the electronic display device 130 may be used, for example, to advertise the locations of businesses near the location of the user, such as restaurants 1250, tourist attractions 1270, service and gas stations 1260, and hotels 1240. Local weather 1280 could also be displayed.

The lightweight materials from which the carrier material 110 may be formed and the flexible property of the carrier material 110 have the advantages of making the map 1200 easily portable, so that unlike fixed devices built into cars, embodiments of the present invention can be taken from a car by a traveler and the traveler can review map information at his convenience. For example, the foldable or rollable map 1200 could be folded or rolled into a tube, and reviewed by a traveler while he is dining in a restaurant or resting in his hotel. The map 1200 may further allow for hikers, campers, and military personnel to find their locations as well as understand the location of roads, landmarks, and scenic or wilderness locations relative to where the map 1200 and, thus, the user is located. Pilots and sailors can utilize the map 1200 to determine their locations. The inventive map will provide a significant feeling of safety, convenience and assistance to the user.

To provide location information as described above, the map 1200 may communicate with wireless or wired systems. The wireless systems may include data networks such as the Internet or World Wide Web and GPS systems. A communication link with such wireless systems may enable a map 1200 to download information needed to generate a corresponding display. FIG. 12A shows elements that may be associated with an implementation of embodiments of the present invention in the form of a map 1200. In addition to elements described with reference to FIG. 2, above, a GPS circuit 1260 and an additional antenna 1250 for communication with GPS satellites may be provided to obtain location information. Details of a map image 1210 may be obtained, for example, by downloading corresponding information from the Internet via a wireless communication link implemented through a transceiver circuit 1270 and an associated antenna 1280. The elements shown in FIG. 12A could be integrated into the structure of the carrier material 110. On the other hand, some elements may be external to the carrier material 110, such as arranged on an attachment thereto. The inventive map disclosed above may allow for the user to map any region in the world and to, for example, identify the user's whereabouts within or with respect to the region, and/or to identify a route of travel and monitor in real time his or her whereabouts on his or her route of travel in the region. The inventive map may further be used to identify, communicate with and learn about important locations for the convenience of the user.

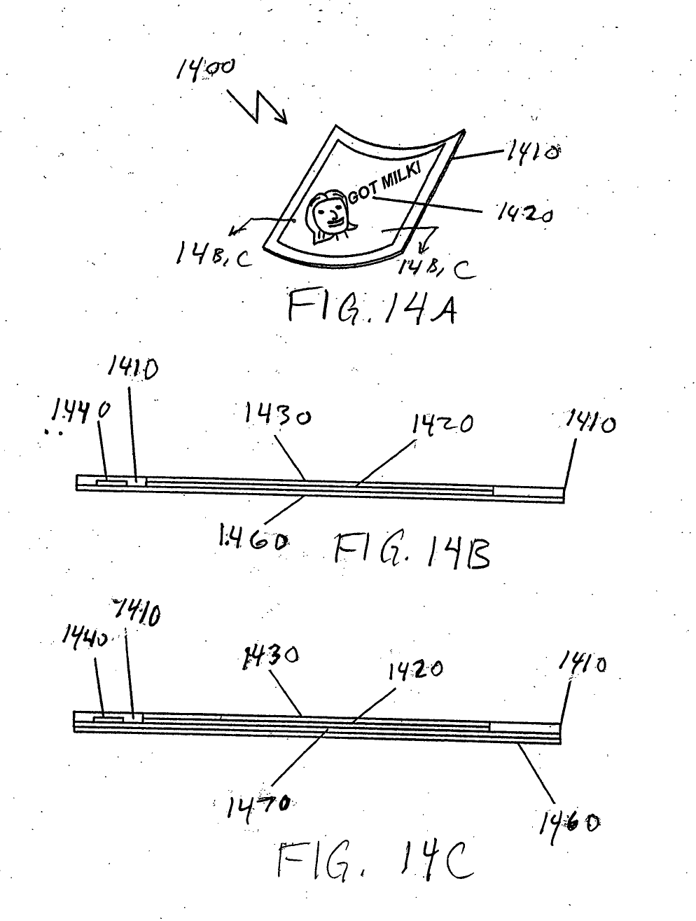

FIG. 13 illustrates yet another use of inventive embodiments of the present invention. In FIG. 13, a flexible carrier material 110 and associated electronic display device 130 form at least part of a floor mat or floor covering 1300 on a floor of a commercial establishment such as a grocery store. The flexible carrier material 110 and associated electronic display device 130 may be used in this way to display advertising content relating to products on a nearby shelf 1301, for example.

In still further applications, inventive embodiments of the present invention could be incorporated into such articles of manufacture such as book binders, notebooks, information packets, organizers, calendars, price hangtags, or product information advertising hangtags.

A further example of an electronic display device according to inventive embodiments of the present invention is shown in FIGS. 14A-14C. According to the embodiments, an electronic display device 1400 could comprise lightweight materials able to flex and bend as shown in FIG. 14A. More specifically, the electronic display device 1400 may include a lightweight flexible display element layer 1420 and a lightweight flexible frame 1410. The display element layer 1420 may comprise such display elements as small molecule OLEDs, polymeric OLEDs, PLEDs or LEPs. FIGS. 14B and 14C are cross-sectional views along lines 14B-14B and 14C-14C, respectively. As shown in FIG. 14B, the flexible frame 1410 may include a lightweight flexible transparent protective layer 1430 and a lightweight flexible backing layer 1460. The display element layer 1420 may be arranged between the backing layer 1460 and the transparent protective layer 1430. The transparent protective layer could comprise, for example, polycarbonate, Mylar, or other rugged transparent plastic. As shown in FIG. 14C, the electronic display device 1400 might further comprise a lightweight flexible thin film battery 1470 to power the display. The thin film battery 1470 could be arranged between the display element layer 1420 and the backing layer 1460.

The electronic display device 1400 may further comprise lightweight control electronics 1440 for driving a display of the display element layer. As shown, the control electronics 1440 may be housed with the frame 1410, laterally to the display element layer 1420. Alternatively, the control electronics could be arranged, for example, between the display element layer 1420 and the backing layer 1460 (FIG. 14B), or between the backing layer 1460 and the thin film battery 1470 (FIG. 14C).

The electronic display device 1400 may be configurable to display electronically modifiable arbitrary content. As noted, an electronic display device 1400 as described above would very lightweight and therefore easily portable. For example, it is contemplated that the electronic display device 1400 could be rolled up and carried under one's arm like a newspaper.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed:

1. A menu comprising:
a flexible carrier material;
an electronic display device associated with the flexible carrier material;
a controller coupled to the electronic display device and programmable to cause the electronic display device to display arbitrary content; and
a memory coupled to the controller to store the content.

2. The menu of claim 1 wherein said menu is capable of wireless communication.

3. The menu of claim 1 wherein said menu is capable of electronically changing one of an item, price, or advertisement.

4. The menu of claim 1 wherein said menu is capable of electronically displaying a dynamic or still image.

5. The menu of claim 1 wherein said menu is connectable to a computer.

6. The menu of claim 1 wherein said menu is connectable to a network.

7. The menu of claim 1 wherein said menu is connectable to the World Wide Web.

8. A poster comprising:
a flexible carrier material;
an electronic display device associated with the flexible carrier material;
a controller coupled to the electronic display device and programmable to cause the electronic display device to display arbitrary content; and
a memory coupled to the controller to store the content.

9. The poster of claim 8 wherein said poster is capable of wireless communication.

10. The poster of claim 8 wherein said poster is capable of electronic changeable advertisements.

11. The poster of claim 8 wherein said poster is capable of electronically displaying a dynamic or still image.

12. The poster of claim 8 wherein said poster is connectable to a computer.

13. The poster of claim 8 wherein said poster is connectable to a network.

14. The poster of claim 8 wherein said poster is connectable to the World Wide Web.

15. A map comprising:
a flexible carrier material;
an electronic display device associated with the flexible carrier material;
a controller coupled to the electronic display device and programmable to cause the electronic display device to display arbitrary content; and
a memory coupled to the controller to store the content.

16. The map of claim 15 wherein said map is at least one of foldable or rollable.

17. The map of claim 15 wherein said map is capable of wireless communication.

18. The map of claim 15 wherein said map is associated with a GPS system.

19. The map of claim 15 wherein said map is capable of identifying whereabouts of a user.

20. The map of claim 15 wherein said map is capable of displaying at least one of a electronic changeable advertisement, location, landmark, or weather information.

21. The map of claim 15 wherein said map is capable of electronically displaying a dynamic or still image.

22. The map of claim 15 wherein said map is connectable to a computer.

23. The map of claim 15 wherein said map is connectable to a network.

24. The map of claim 15 wherein said map is connectable to the World Wide Web.

25. A publication cover comprising:
a flexible carrier material;
an electronic display device associated with the flexible carrier material;
a controller coupled to the electronic display device and programmable to cause the electronic display device to display arbitrary content; and
a memory coupled to the controller to store the content.

26. The publication cover of claim 25 wherein said cover is capable of wireless communication.

27. The publication cover of claim 25 wherein said cover is capable of displaying an electronic changeable advertisement or message.

28. The publication cover of claim 25 wherein said cover is capable of electronically displaying a dynamic or still image.

29. The publication cover of claim 25 wherein said cover is connectable to a computer.

30. The publication cover of claim 25 wherein said cover is connectable to a network.

31. The publication cover of claim 25 wherein said cover is connectable to the World Wide Web.

32. A place mat comprising:
a flexible carrier material;
an electronic display device associated with the flexible carrier material;
a controller coupled to the electronic display device and programmable to cause the electronic display device to display arbitrary content; and
a memory coupled to the controller to store the content.

33. The place mat of claim 32 wherein said place mat is capable of wireless communication.

34. The place mat of claim 32 wherein said place mat is capable of providing a game.

35. The place mat of claim 34 wherein said game is interactive.

36. The place mat of claim 32 wherein said place mat is capable of electronically displaying a dynamic or still image.

37. The place mat of claim 32 wherein said place mat is capable of displaying an electronic changeable advertisement.

38. The place mat of claim 32 wherein said place mat is connectable to a computer.

39. The place mat of claim 32 wherein said place mat is connectable to a network.

40. The place mat of claim 32 wherein said place mat is connectable to the World Wide Web.
